(19) United States
(12) Patent Application Publication
(10) Pub. No.: US 2006/0197745 A1
(43) Pub. Date: Sep. 7, 2006

(54) Remote control device and display control device

(75) Inventor: Yukio Yokozawa, Shiojiri (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/365,892

(22) Filed: Feb. 28, 2006

(30) Foreign Application Priority Data
Mar. 1, 2005 (JP) 2005-055438

(51) Int. Cl. G09G 5/08

(52) U.S. Cl. 345/158

(57) ABSTRACT

A remote control device includes: a housing that has an external dimension allowing the housing to be handled by a user such that a position and a posture thereof are changed and houses predetermined components therein; a relative displacement detecting unit that detects a relative change in the position and the posture of the housing in a non-contact manner; a cursor moving operation signal forming unit that forms a cursor moving operation signal for moving a cursor, which is projected on a display screen of a predetermined display control device, according to a detection output of the relative displacement detecting unit; a cursor moving operation signal sending unit that sends the cursor moving operation signal formed by the cursor moving operation signal forming unit to the display control device as a signal of a predetermined form; a deciding operation receiving unit that receives deciding operation by the user concerning a position of the cursor projected on the display screen of the display control device; a deciding operation signal forming unit that forms a deciding operation signal in response to the operation applied to the deciding operation receiving unit; and a deciding operation signal sending unit that sends the deciding operation signal formed by the deciding operation signal forming unit to the display control device as a signal of a predetermined form.

### BACKGROUND

1. Technical Field

The present invention relates to a remote control device that is held and operated by a user, a display control device corresponding to the remote control device, and a remote control system. As an example, the invention relates to a remote control device that has an external shape like a remote controller used for remote operation of a television receiver and can emit a control signal by radio when a user holds the remote control device and applies a specific motion to the same, a display control device that moves a cursor on a display annexed to the display control device according to the control signal emitted from the remote control device, recognizes operation for deciding a position of the cursor, and gives a control signal to a control object apparatus on the basis of the recognition to control the control object apparatus, and a control system including these devices.

2. Related Art

In recent years, for example, it is usual to remotely control various control object apparatuses used in the home with remote control devices (remote controllers) at hand. More specifically, many apparatuses such as video recording and reproduction apparatuses (a television receiver, a Digital Versatile Disk (DVD) recorder, a Hard Disk Drive (HDD) recorder, a Vide Tape Recorder (VTR), etc.) and an audio system are remotely operated by remote controllers using infrared rays.

When there are many apparatuses that are remotely operated by the remote controllers in this way, people feel it extremely annoying to use a dedicated remote controller for each of the control object apparatuses. Actually, people feel it more annoying to properly store and manage the remote controllers for the respective control object apparatuses. In view of such problems in handling of the remote controllers, measures for solving the problems have been proposed.

For example, there is a proposal to make it possible to lightly and intuitively operate a broadcast receiver. In this proposal, a remote controller detects its own movement with an inertia sensor such as a gyro sensor and outputs a control signal corresponding to the movement as a code signal. On the broadcast receiver side, a function for controlling the broadcast receiver according to the code signal outputted is set in a code signal function setting unit. The broadcast receiver performs control based on the set function according to a code signal generated and outputted in response to the movement of the remote controller. Consequently, a user can lightly and intuitively operate the broadcast receiver by moving a position and a posture of the remote controller (see, for example, JP-A-2004-173003 (paragraphs 0011 to 0013 and FIG. 1).

A technique for making it possible to operate plural kinds of control object apparatuses as intended by operating one operation unit (a joy stick) is also proposed. In the technique, a signal of an infrared ray is projected according to a state of operation of a joy stick provided in a remote controller, temporarily received by a light-receiving unit in a television receiver, converted into an infrared control signal conforming to predetermined operation of an object apparatus (e.g., an apparatus to be operated among plural VTRs provided) in the television receiver, and projected on the object apparatus.

In the case of this proposal, as an image representing an operation unit of the control object apparatus (VTR), a layout diagram of an operation switch of a remote controller exclusively used for the apparatus (VTR) is projected to be superimposed in a screen of a video, which is to be originally displayed in the television receiver, in a form of a so-called picture-in-picture. A user moves an indicator and decides a position of the indicator on the screen with respect to the layout diagram of the operation switch to perform predetermined operation (see, for example, Japanese Patent No. 3291765 (paragraphs 0056 to 0066 and FIGS. 6 and 8).

Moreover, a system that makes it possible to remotely control plural control object apparatuses with one remote controller is proposed. In this system, a user remotely operates an operation menu on a screen of a television receiver according to operation of a cursor movement button provided on the remote controller. Then, an MPU in the television receiver generates a control signal corresponding to the operation, sends a control signal to an infrared control signal projection device, which is attached to a ceiling of a room where the television receiver and the control object apparatuses are set, from an indoor antenna. The infrared control signal projection device receives the control signal and projects an infrared ray on a target control object apparatus in the room as a remote control signal. Consequently, the control object apparatus is controlled as intended by the user (see, for example, JP-A-2003-209895 (paragraphs 0013 to 0021 and FIGS. 1 and 2).

In the technique for simply operating a control object apparatus according to a code signal outputted in response to movement of a remote controller disclosed in JP-A-2004-173003, it is possible to operate the control object apparatus according to an intuitive motion (a way of moving the remote controller itself) for which special proficiency is not required. However, the remote controller and the control object apparatus are still provided in a one-to-one relation.

Therefore, a user is required to prepare dedicated remote controllers for respective control object apparatuses that are desired to be remotely controlled. If the dedicated remote controllers have to be prepared for the respective control object apparatuses in this way, the user is extremely annoyed by a method of .storing the remote controllers and a way of selecting a remote controller when the user uses the remote controller. In this regard, the problems in the past are not solved.

In the technique proposed in Japanese Patent No. 3291765, it is possible to remotely operate plural kinds of control object apparatuses with a single remote controller including a joy stick. However, actually, a user virtually performs key operation according to operation of the joy stick while visually recognizing, on a display screen, an original arrangement of operation keys of the remote controller corresponding to the respective control object apparatuses. In order to freely operate the respective control object apparatuses as desired according to such a method, the user is required to be more proficient compared with the case in which the user operates dedicated remote controllers for the respective control object apparatuses.

The proposal disclosed in JP-A-2003-209895 also makes it possible to remotely operate plural kinds of control object apparatuses selectively with one remote controller. However, a user is required to be accustomed to operation of keys (a cursor movement button) of the remote controller itself. In addition, it is essential to provide an infrared control signal projection device attached to a ceiling other than the remote controller, a television receiver to be controlled, and the like. This makes a constitution of a system complicated and involves troubles and expenses in that work for initial installation and transfer of the infrared control signal projection apparatus is required.

### SUMMARY

An advantage of some aspects of the invention is to provide a remote control device, a display control device, and a control system including the remote control device and the display control device with which a user can control plural control object apparatuses easily with simple operation. The remote control device (a remote controller) emits a control signal according to relatively simple operation (i.e., a way of swinging), which is easily understood intuitively, of holding the remote control device itself and changing a position and a posture thereof. The display control device responds to the control signal emitted from the remote control device. The display control device recognizes movement of a cursor and operation for deciding a position of the cursor on a display annexed to the display control device itself and gives a control signal to the control object apparatuses on the basis of the recognition. Therefore, it is possible to control the control object apparatuses via the display control device and control the control object apparatuses with a single common remote control device.

According to a first aspect of the invention, there is provided a remote control device including a housing, a relative displacement detecting unit, a cursor moving operation signal forming unit, a cursor moving operation signal sending unit, a deciding operation receiving unit, a deciding operation signal forming unit, and A deciding operation signal sending unit. The housing has an external dimension allowing the housing to be handled by a user such that a position and a posture thereof are changed and houses predetermined components therein. The relative displacement detecting unit detects a relative change in the position and the posture of the housing in a non-contact manner. The cursor moving operation signal forming unit forms a cursor moving operation signal for moving a cursor, which is projected on a display screen of a predetermined display control device, according to a detection output of the relative displacement detecting unit. The cursor moving operation signal sending unit sends the cursor moving operation signal formed by the cursor moving operation signal forming unit to the display control device as a signal of a predetermined form. The deciding operation receiving unit receives deciding operation by the user concerning a position of the cursor projected on the display screen of the display control device. The deciding operation signal forming unit forms a deciding operation signal in response to the operation applied to the deciding operation receiving unit. The deciding operation signal sending unit sends the deciding operation signal formed by the deciding operation signal forming unit to the display control device as a signal of a predetermined form.

According to the remote control device described above, when a user holds and moves the housing to change a position and a posture thereof, the relative displacement detecting unit detects a relative change in the position and the posture. The cursor moving operation signal forming unit forms a cursor moving operation signal for moving a cursor (e.g., an arrow-shaped cursor pointer), which is projected on the display screen of the predetermined display control device, according to an output of the detection. The cursor moving operation signal sending unit sends the cursor moving operation signal formed to the display control device as a signal of a predetermined form. On the other hand, the deciding operation receiving unit that receives deciding operation by the user for a position of the cursor projected on the display screen of the display control device is provided. When the user operates the deciding operation receiving unit to perform deciding operation, the deciding operation signal sending unit sends a deciding operation signal formed by the deciding operation signal forming unit to the display control device as a signal of a predetermined form. Consequently, the remote control device can execute remote operation for *moving the cursor and deciding a position of the cursor in the predetermined display control device corresponding to the remote control device.

According to a second aspect of the invention, there is provided a display control device that moves a cursor projected on a display screen in response to a cursor moving operation signal sent from a predetermined remote control device and recognizes deciding operation for a position of the cursor in response to a deciding operation signal sent from the remote control device. The display control device includes a control operation pattern projecting unit, a control operation specifying signal generating unit, a control object apparatus operation signal forming unit, and a control object apparatus operation signal sending unit. The control operation pattern projecting unit projects a control operation pattern, which specifies a type of control operation for control, of a predetermined control object apparatus, on the display screen. The control operation specifying signal generating unit generates, when the deciding operation for a position of the cursor is recognized in response to the deciding operation signal when the cursor moved in response to the cursor moving operation signal is located in a portion representing one type of control operation in the control operation pattern projected on the display screen by the control operation pattern projecting unit, a control operation specifying signal representing the one type of control operation. The control object apparatus operation signal forming unit forms a control object apparatus operation signal conforming to operation of the control object apparatus on the basis of the control operation specifying signal generated by the control operation specifying signal generating unit. The control object apparatus operation signal sending unit sends the control object apparatus operation signal formed by the control object apparatus operation signal forming unit to the control object apparatus.

According to the display control device described above, the control operation pattern projecting unit projects a control operation pattern on the display screen annexed to the display control device (regardless of whether the display screen is integral with or separate from the display control device). The control operation pattern specifies a type of control operation (start, stop, pause, EPG operation, etc.) for control of the predetermined control object apparatus (e.g., a Personal Video Recorder (PVR) or a Video Cassette Recorder (VCR)). Concerning the control operation pattern, movement of a cursor and decision of “a” position of the cursor are executed in response to a cursor moving operation signal and a deciding operation signal supplied from the remote control device operated by the user. A type of control operation is decided according to the movement of the cursor and the decision of a position of the cursor executed. The control operation specifying signal generating unit generates a control operation specifying signal corresponding to the type of control operation decided. The control object apparatus operation signal forming unit forms a control object apparatus operation signal conforming to operation of the control object apparatus (e.g., any one of the PVR, VCR, and the like) on the basis of the control operation specifying signal generated. The control object apparatus operation signal sending unit sends the control object apparatus operation signal formed in this way to the control object apparatus. This makes it possible to control various target control object apparatuses via the display control device while moving the cursor and deciding a position of the cursor on the display screen, which is annexed to the display control device, with one remote control device.

According to a third aspect of the invention, there is provided a control system including a remote control device, a display control device, and a control object apparatus. The remote control device includes a housing, a cursor moving operation signal sending unit, and a deciding operation signal sending unit. The housing has an external dimension allowing the housing to be handled by a user such that a position and a posture thereof are changed and houses predetermined components therein. The cursor moving operation signal sending unit sends a cursor moving operation signal for moving a cursor projected on a display screen of a predetermined display control device according to a position and a posture of the housing to the display control device as a signal of a predetermined form. The deciding operation signal sending unit sends a deciding operation signal for causing the display control device to recognize deciding operation by the user concerning a position of the cursor projected on the display screen of the display control device to the display control device as a signal of a predetermined form. The display control device corresponds to the predetermined display control device. The display control device includes a control operation pattern projecting unit, a control operation specifying signal generating unit, a control object apparatus operation signal forming unit, and a control object apparatus operation signal sending unit. The control operation pattern projecting unit projects a control operation pattern, which specifies a type of control operation for control of a predetermined control object apparatus, on the display screen. The control operation specifying signal generating unit generates, when the deciding operation for a position of the cursor is recognized in response to the deciding operation signal when the cursor moved in response to the cursor moving operation signal is located in a portion representing one type of control operation in the control operation pattern projected on the display screen by the control operation pattern projecting unit, a control operation specifying signal representing the one type of control operation. The control object apparatus operation signal forming unit forms a control object apparatus operation signal conforming to operation of the control object apparatus on the basis of the control operation specifying signal generated by the control operation specifying signal generating unit. The control object apparatus operation signal sending unit sends the control object apparatus operation signal formed by the control object apparatus operation signal forming unit to the control object apparatus. The control object apparatus is constituted to operate in a predetermined operation form in response to the control object apparatus operation signal sent from the display-control device.

According to the control system described above, a cursor moving operation signal is generated when the user holds and moves the remote control device to change a position and a posture of the remote control device. A deciding operation signal is generated when the user operates the deciding operation receiving unit. Both the signals are supplied to the display control device. The display control device receives the supply of the signals and, in response to the cursor moving operation signal and the deciding operation signal, executes operation for moving the cursor and deciding (specifying) a position of the cursor on a control operation pattern. The control operation pattern specifies a type of control operation (start, stop, pause, EPG operation, etc.) for control of a predetermined control object apparatus (e.g., a PVR or a VCR) projected on the display screen by the control operation pattern projecting unit. The display screen is annexed to the display control device (regardless of whether the display screen is integral with or separate from the display control device). The control operation specifying signal generating unit generates a control operation specifying signal representing the one type of control operation specified in this way. The control object apparatus operation signal forming unit generates a control object apparatus operation signal conforming to operation of the control object apparatus selected as an object of control at that point on the basis of the control operation specifying signal generated. The control object apparatus operation signal sending unit sends the control object apparatus operation signal formed by the control object apparatus operation signal forming unit in this way to the control object apparatus. The control object apparatus operates in a predetermined operation form in response to the control object apparatus operation signal supplied. This makes it possible to control various target control object apparatuses via the display control device while moving the cursor and deciding a position of the cursor on the display screen, which is annexed to the display control device, with one remote control device.

According to a fourth aspect of the invention, there is provided a display control device that moves a cursor projected on a display screen in response to a cursor moving operation signal sent from a predetermined remote control device and recognizes deciding operation for a position of the cursor in response to a deciding operation signal sent from the remote control device. The display control device includes a control operation pattern selecting and projecting unit, a control object apparatus operation signal forming unit, and a control object apparatus operation signal sending unit. The control operation pattern selecting and projecting unit projects a control operation pattern including respective patterns on the display screen selectively out of displayable control operation patterns corresponding to the plural control object apparatuses. The patterns specify a type of control operation for control of one control object apparatus among predetermined plural control object apparatuses. The control object apparatus operation signal forming unit forms, when the deciding operation for a position of the cursor is recognized in response to the deciding operation signal when the cursor moved in response to the cursor moving operation signal is located in a portion representing one type of control operation in the control operation pattern projected on the display screen by the control operation pattern projecting unit, a control object apparatus operation signal conforming to operation of the control object apparatus corresponding to the one type of control operation. The control object apparatus operation signal sending unit sends the control object apparatus operation signal formed by the control object apparatus operation signal forming unit to the control object apparatus.

According to the display control device described above, the control operation pattern selecting and projecting unit projects a control operation pattern (e.g., pattern display similar to a usual operation key arrangement of a remote controller) including respective patterns on the display screen selectively out of displayable control operation patterns corresponding to the plural control object apparatuses. The patterns specify a type of control operation (start, stop, pause, EPG operation, etc.) for control of one control object apparatus among the predetermined plural control object apparatuses (e.g., a PVR and a VCR). The control object apparatus operation signal forming unit forms a control object apparatus operation signal (an operation signal for causing the control object apparatus to perform any one of start, stop, pause, EPG operation, and the like) conforming to operation of the control object apparatus corresponding to the one type of control operation decided in response to operation for moving the cursor and deciding a position of the cursor in the control operation pattern projected on the display screen in this way. The control object apparatus operation signal sending unit sends the control object apparatus operation signal formed to the control object apparatus. This makes it possible to control various target control object apparatuses via the display control device while moving the cursor and deciding a position of the cursor on the display screen, which is annexed to the display control device, with one remote control device.

According to a fifth aspect of the invention, there is provided a control system including, a remote control device, a display control device, and a control object apparatus. The remote control device includes a housing, a cursor moving operation signal sending unit, and a deciding operation signal sending unit. The housing has an external dimension allowing the housing to be handled by a user such that a position and a posture thereof are changed and houses predetermined components therein. The cursor moving operation signal sending unit sends a cursor moving operation signal for moving a cursor projected on a display screen of a predetermined display control device according to a position and a posture of the housing to the display control device as a signal of a predetermined form. The deciding operation signal sending unit sends a deciding operation signal for causing the display control device to recognize deciding operation by the user concerning a position of the cursor projected on the display screen of the display control device to the display control device as a signal of a predetermined form. The display control device corresponds to the predetermined display control device. The display control device includes a control operation pattern selecting and projecting unit, a control object apparatus operation signal forming unit, and a control object apparatus operation signal sending unit. The control operation pattern selecting and projecting unit projects a control operation pattern including respective patterns on the display screen selectively out of displayable control operation patterns corresponding to the plural control object apparatuses. The patterns specify a type of control operation for control of one control object apparatus among predetermined plural control object apparatuses. The control object apparatus operation signal forming unit forms, when the deciding operation for a position of the cursor is recognized in response to the deciding operation signal when the cursor moved in response to the cursor moving operation signal is located in a portion representing one type of control operation in the control operation pattern projected on the display screen by the control operation pattern selecting and projecting unit, a control object apparatus operation signal representing the one type of control operation and conforming to operation of the control object apparatus. The control object apparatus operation signal sending unit sends the control object apparatus operation signal formed by the control object apparatus operation signal forming unit to the control object apparatus. The control object apparatus is constituted to operate in a predetermined operation form in response to the control object apparatus operation signal sent from the display control device.

According to the control system described above, a cursor moving operation signal is generated when the user holds and moves the remote control device to change a position and a posture of the remote control device. A deciding operation signal is generated when the user operates the deciding operation receiving unit. Both the signals are supplied to the display control device. On the other hand, on the display control device side, the control operation pattern selecting and projecting unit projects a control operation pattern (e.g., a pattern display similar to a usual operation key arrangement of a remote controller) including respective patterns on the display screen selectively out of displayable control operation patterns corresponding to the plural control object apparatuses. The patterns specify a type of control operation (start, stop, pause, EPG operation, etc.) for control of one control object apparatus among the predetermined plural control object apparatuses (e.g., a PVR and a VCR). The control object apparatus operation signal forming unit forms a control object apparatus operation signal (an operation signal for causing the control object apparatus to perform any one of start, stop, pause, EPG operation, and the like) conforming to operation of the control object apparatus corresponding to the one type of control operation decided in response to operation for moving the cursor and deciding a position of the cursor by the remote control device with respect to the control operation pattern projected on the display screen in this way. The control object apparatus operation signal sending unit sends the control object apparatus operation signal formed to the control object apparatus. The control object apparatus operates in a predetermined operation form in response to the control object apparatus operation signal supplied. This makes it possible to control various target control object apparatuses via the display control device while moving the cursor and deciding a position of the cursor on the display screen, which is annexed to the display control device, with one remote control device.

It is preferable that the control object apparatus operation signal forming unit forms, on the basis of the control operation specifying signal supplied thereto, a control object apparatus operation signal corresponding to the control operation specifying signal with reference to table data. The table data specifies a relation among control object apparatus operation signals for respective control object apparatuses corresponding to types of control operation.

According to the display control device described above, in particular, it is possible to obtain control object apparatus operation signals for controlling a large number of or many kinds of control object apparatuses, respectively, according to a combination of one remote control device and one display control device with reference to the table data. The table data specifies a relation among control object apparatus operation signals for respective control object apparatuses corresponding to types of control operation and control these respective control object apparatuses.

It is preferable that the display control device further includes a data acquiring unit that acquires data forming the table data from the outside through a signal transmission path. The control object apparatus operation signal forming unit forms, on the basis of the control operation specifying signal supplied thereto, a control object apparatus operation signal corresponding to the control operation specifying signal with reference to table data including the data acquired by the data acquiring unit.

According to the display control device described above, in particular, the control object apparatus operation signal forming unit forms a control object apparatus operation signal corresponding to a control operation specifying signal supplied thereto with reference to the table data. The table data includes data acquired by the data acquiring unit from a database or the like on the outside through a signal transmission path such as an IP network. Thus, it is possible to easily cope with update and the like of the data forming the table data.

It is preferable that the display control device further includes a GUI data forming unit that forms data forming the table data by receiving operation by the user. The control object apparatus operation signal forming unit forms, on the basis of the control operation specifying signal supplied thereto, a control object apparatus operation signal corresponding to the control operation specifying signal with reference to the table data including the data formed by the GUI data forming unit.

According to the display control device described above, in particular, it is possible to obtain control object apparatus operation signals for controlling a large number of or many kinds of control object apparatuses, respectively, according to a combination of one remote control device and one display control device with reference to the table data. The table data includes data formed by the user through the GUI data forming unit at the time of initial use and conforms to the respective control object apparatuses as intended. It is possible to accurately control the respective control object apparatuses.

It is preferable that the control object apparatus operation signal sending unit sends a control object apparatus operation signal of an infrared ray to the control object apparatus.

According to the display control device described above, in particular, it is possible to control the control object apparatus according to a control object apparatus operation signal of an infrared ray widely used. Thus, it is possible to cope with various kinds of control object apparatuses.

It is preferable that the control object apparatus operation signal sending unit sends a control object apparatus operation signal to the control object apparatus in a communication system complying with a guideline set by the Digital Living Network Alliance (DLNA).

According to the display control device described above, in particular, it is possible to realize a way of making it possible to control various control object apparatuses complying with the guideline set by the DLNA and exchange data such as contents.

It is preferable that the display control device further includes a pattern data acquiring unit that acquires data representing a control operation pattern including respective patterns, which specify types of control operation for control of a corresponding control object apparatus, from the outside through a signal transmission path. The control operation pattern selecting and projecting unit projects a control operation pattern on the display screen on the basis of the data acquired through the pattern data acquiring unit.

According to the display control device described above, in particular, a control operation pattern is projected on the display screen on the basis of data acquired by the pattern data acquiring unit from a database or the like on the outside through a signal transmission path such as an IP network. Even in a tendency in which new apparatuses that can be control object apparatuses are added, it is possible to easily cope with the new apparatuses by acquiring control operation patterns conforming to the new apparatuses and the like from the database or the like on the outside with the pattern data acquiring unit.

It is preferable that the display control device further includes a pattern correspondence operation data acquiring unit that acquires data representing a correspondence relation between respective patterns in the control operation pattern and types of control operation for control of a corresponding control object apparatus from the outside through a signal transmission path. The control object apparatus operation signal forming unit forms a control object apparatus operation signal on the basis of the data acquired by the pattern correspondence operation data acquiring unit.

According to the display control device described above, in particular, a control object apparatus operation signal is formed on the basis of data acquired by the pattern correspondence operation data acquiring unit from the database or the like on the outside through a signal transmission path such as an IP network. Even if a new apparatus that can be a control object apparatus is added or a control code is changed, it is possible to easily cope with the addition of the new apparatus or the change of the control code.

It is preferable that the display control device further includes a GUI data forming unit that forms data by receiving interactive operation using a GUI by the user. The pattern correspondence operation data acquiring unit acquires data representing a correspondence relation between respective patterns in the control operation pattern and types of control operation for control of a corresponding control object apparatus through the GUI data forming unit.

According to the display control device described above, in particular, data representing a correspondence relation between respective patterns in the control operation pattern and types of control operation for control of a corresponding object apparatus is prepared on the basis of intended data formed by the user at the time of initial use or the like through the GUI data forming unit. Thus, it is possible to obtain control object apparatus operation signals for controlling a large number of or many kinds of control object apparatuses, respectively, according to a combination of one remote control device and one display control device and accurately control these respective control object apparatuses.

It is preferable that the control object apparatus operation signal sending unit sends a control object apparatus operation signal of an infrared ray to the control object apparatus.

According to the display control device described above, in particular, it is possible to control the control object apparatus according to a control object apparatus operation signal of an infrared ray widely used. Thus, it is possible to cope with various kinds of control object apparatuses.

It is preferable that the control object apparatus operation signal sending unit sends a control object apparatus operation signal to the control object apparatus in a communication system complying with a guideline set by the Digital Living Network Alliance (DLNA).

According to the display control device described above, in particular, it is possible to realize a way of making it possible to control various control object apparatuses complying with the guideline set by the DLNA and exchange data such as contents.

### BRIEF DESCRIPTION OF THE DRAWINGS

The invention will be described with reference to the accompanying drawings, wherein like numbers reference like elements.

FIG. 1 is a conceptual diagram representing a control system according to an embodiment of the invention.

FIG. 2 is a block diagram showing a constitution of a digital television serving as a display control device in the control system in FIG. 1.

FIG. 3 is a block diagram showing a constitution of a remote controller serving as a remote control device in the control system in FIG. 1.

FIG. 4 is a diagram representing an example of display on a screen in a control mode of the digital television serving as the display control device according to the embodiment of the invention.

FIG. 5 is a diagram representing an example of display on a screen in a control mode of a digital television serving as a display control device according to a modification of the embodiment in FIG. 4.

FIG. 6 is a flowchart representing operations in the control mode of the display control devices in FIGS. 1, 2, 4, and 5.

FIG. 7 is a flowchart representing a preparation operation for a function for making it possible to perform the operations in FIG. 6 to be given to the display control device.

FIG. 8 is a flowchart representing a preparation operation for a function for making it possible to perform the operations in FIG. 6 to be given to the display control device.

FIG. 9 is a flowchart representing a preparation operation for a function for making it possible to perform the operations in FIG. 6 to be given to the display control device.

### DESCRIPTION OF EXEMPLARY EMBODIMENTS

Exemplary embodiments of the invention will be hereinafter explained with reference to the accompanying drawings. In the drawings, for convenience of explanation, main parts forming subjects of explanation are exaggerated according to circumstances and other parts are simplified or omitted according to circumstances.

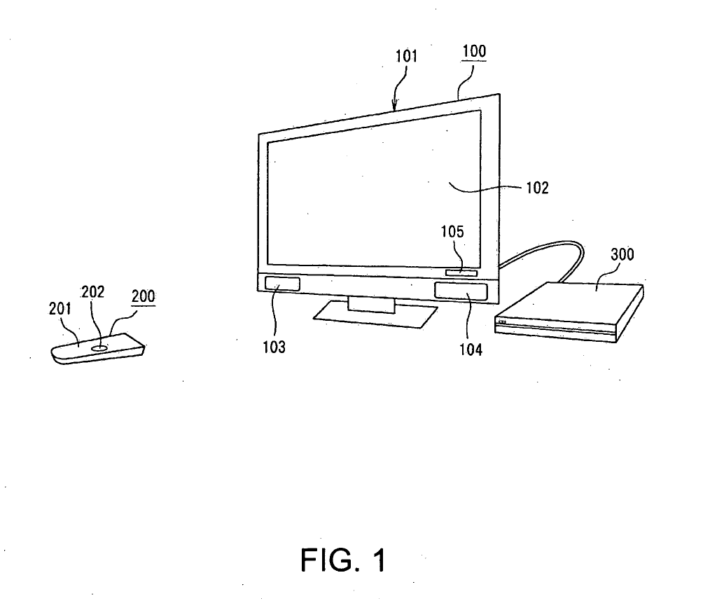

FIG. 1 is a conceptual diagram representing a control system (a remote control system for a Personal Video Recorder (PVR) operating via a digital television receiver) according to an embodiment of the invention including a display control device (a digital television receiver body), a remote control device (a remote controller corresponding to the digital television receiver body), and a control object apparatus (a PVR).

In FIG. 1, a digital television receiver body (hereinafter referred to as digital television) 100 serving as a display control device receives a cursor moving operation signal Sc and a deciding operation signal Sd formed by radio signals from a remote controller 200 serving as a remote control device corresponding to the digital television. Movement of a cursor (e.g., an arrow-shaped cursor pointer) and an operation for deciding a position of the cursor are controlled on a screen of the digital television.

A control signal formed by the digital television 100 serving as the display control device is supplied to a control object apparatus, for example, a PVR 300 on the basis of operation of the remote controller 200. The PVR 300 operates in a predetermined form.

The digital television 100 projects a video on a screen 102 of a housing 101 thereof in a usual manner. When the digital television 100 functions as a display control device described below in detail, the digital television 100 causes a control operation pattern projecting unit to project a control operation pattern (e.g., pattern display like buttons corresponding to functions of operation keys of a dedicated remote controller attached to the PVR 300), which specifies types of control operation (start, stop, pause, EPG operation, etc.) for control of a predetermined control object apparatus (e.g., a PVR or a VCR; in the case of FIG. 1, the PVR 300), on the screen 102 serving as a display screen of a display annexed to the display control device (regardless of whether the display screen is integral with or separate from the display control device.

According to this control operation pattern, movement of the cursor and decision of a position of the cursor are executed in response to the cursor moving operation signal Sc and the deciding operation signal Sd supplied, by radio, from the remote controller 200 operated by a user. A type of control operation is decided according to the movement of the cursor and the decision of a position of the cursor executed.

A control operation specifying signal generating unit generates a control operation specifying signal corresponding to the type of control operation decided. A control object apparatus operation signal forming unit forms a control object apparatus operation signal conforming to operation of the control object apparatus (in the case of FIG. 1, the PVR 300) on the basis of the control operation specifying signal generated.

In the digital television 100, a left side speaker 103 and a right side speaker 104 constituting a stereo acoustic device are provided in positions lower than a base of the screen 102. A light-receiving window 105 that receives a usual control signal of an infrared ray or the like from the remote controller 200 is provided on the right directly below the bottom of the screen 102.

On the other hand, the remote controller 200 has an independent housing 201 that can be arranged in a position separated from the digital television 100 (the housing 101 thereof). The housing 201 has an external dimension allowing the housing 201 to be handled by the user such that a position and a posture thereof change. A deciding operation button 202 is arranged on an upper surface of the housing 201. The housing 201 houses predetermined components, which are described in detail later with reference to the drawings, therein.

To describe the components briefly, the components include a relative displacement detecting unit generally referred to as, for example, a gyro sensor, a cursor moving operation signal forming unit, a cursor moving operation signal sending unit, a deciding operation receiving unit, a deciding operation signal forming unit, and a deciding operation signal sending unit. The relative displacement detecting unit detects a relative changes in a position and a posture of the housing 201 in a non-contact manner. The cursor moving operation signal forming unit forms the cursor moving operation signal Sc for moving a cursor, which is, for example, an arrow-shaped cursor (pointer), projected on the display screen (the screen 102) of the display control device (the digital television 100) according to a detection output of the relative displacement detecting unit. The cursor moving operation signal sending unit sends the cursor moving operation signal Sc formed by the cursor moving operation signal forming unit to the digital television 100 as a signal of a predetermined form. The deciding operation receiving unit receives deciding operation by the user for a position of the cursor projected on the screen 102 of the digital television 100 (a circuit unit or the like that receives operation applied to the deciding operation button 202). The deciding operation signal forming unit forms the deciding operation signal Sd in response to operation applied to the deciding operation receiving unit. the deciding operation signal sending unit sends the deciding operation signal Sd formed by the deciding operation signal forming unit to the digital television 100 as a signal of a predetermined form.

The control system according to this embodiment includes the digital television 100, the remote controller 200, and the control object apparatus, for example, the PVR 300.

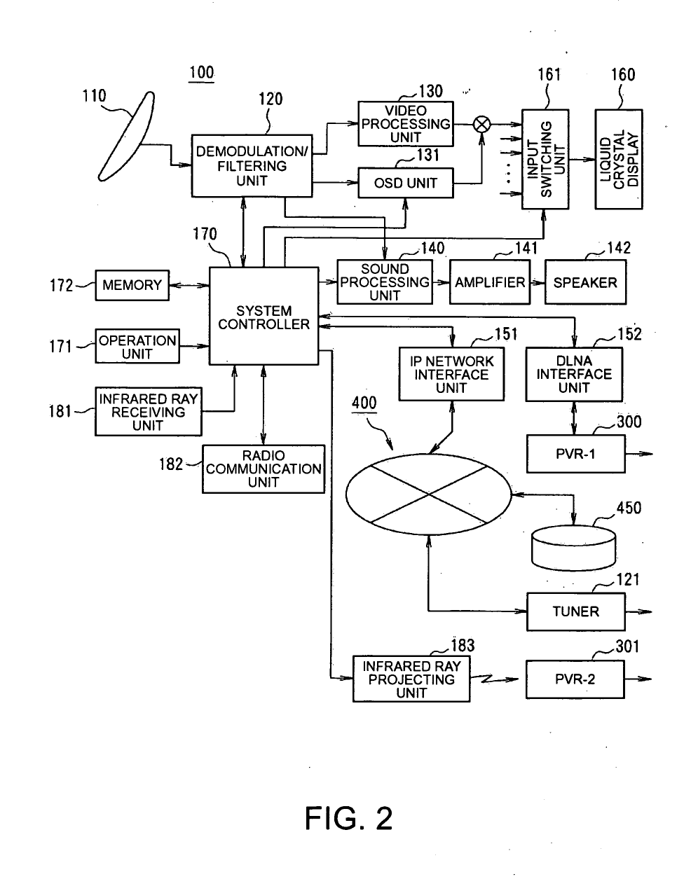

FIG. 2 is a block diagram showing a constitution of the digital television 100 in FIG. 1. A broadcast wave received by an antenna 110 is demodulated by a demodulation/filtering unit 120. The demodulation/filtering unit 120 extracts a transport stream from the broadcast wave and performs filtering for acquiring a video, a sound, and program information corresponding to tuning by a viewer (user). A video output, a sound output, and program information from the modulation/filtering unit 120 are supplied to a video processing unit 130, a sound processing unit 140, and an On-Screen-Display (OSD) unit 131, respectively.

An output from the OSD unit 131 is superimposed on an output from the video processing unit 130. A video is projected on a liquid crystal display 160 according to a video signal with such program information superimposed thereon. In a pre-stage of the liquid crystal display 160, other than the video processing unit 130 (a tuner output), an input switching unit 161 that selectively supplies any one of outputs of other various video reproduction devices such as the PVR 300 to a display device is interposed.

The display device (in this embodiment, the liquid crystal display 160) itself may be applied to the digital television 100 regardless of whether the display device is provided in the digital television 100 or provided outside.

Program information is displayed on the screen of the liquid crystal display 160 on the basis of an output of the OSD unit 131 and the digital television 100 functions as a display control device for performing control for a control object apparatus. In this case, a control operation pattern (pattern display like buttons equivalent to functions of operation keys of a remote controller, etc.) is displayed to occupy a part of the screen and a specific cursor of an arrow shape or the like is displayed in a target position on the control operation pattern to be superimposed thereon.

A Graphical User Interface of the digital television 100, which is displayed as described above as an example, is realized by supplying a signal for projecting a predetermined pattern on the liquid crystal display 160 from the OSD unit 131. Details of the GUI will be described later.

On the other hand, an output of the sound processing unit 140 that processes a sound signal from the demodulation/filtering unit 120 is supplied to a speaker 142 corresponding thereto via an amplifier 141 and a stereo sound is emitted. Since the stereo sound is emitted in this way, the amplifier 141 and the speaker 142 are prepared in two systems of a left channel and a right channel. However, in FIG. 2, both the systems are shown as one system for convenience of illustration.

A system controller 170 including a microprocessor as a main component is provided. The microprocessor comprehensively controls the entire system of the digital television 100 including the demodulation/filtering unit 120, the sound processing unit 140, the OSD unit 131, and the input switching unit 161. An output of an operation unit 171 including operation keys and the like that receives operation by the viewer (user) is supplied to the system controller 170. A memory 172 is accessibly connected to the system controller 170. Storage and readout of data (information) are executed at required timing.

On the other hand, an output of an infrared ray receiving unit 181 and a radio communication unit 182 are connected to the system controller 170 to operate under the control of the system controller 170. The infrared ray receiving unit 181 is provided behind the light-receiving window 105, which is described with reference to FIG. 1, to receive a usual signal of an infrared ray for remotely controlling the digital television 100. The radio communication unit 182 performs radio communication conforming to Bluetooth®, IEEE803.11a, or IEEE803.11b and exchanges signals related to movement of the cursor and decision of a position of the cursor on the screen of the liquid crystal display 160 with the remote controller 200 corresponding thereto. In the above description, the infrared ray receiving unit 181 receives a signal of an infrared ray concerning control for basic operations such as on/off of a power supply and adjustment of a sound volume given from a remote controller corresponding thereto. The infrared ray receiving unit 181 allows the digital television 100 to perform, under the control of the system controller 170, an operation in an infrared control mode in which the digital television 100 can actuate for itself and not for control of other control object apparatuses.

Moreover, an IP network interface unit 151 for making it possible to connect the system controller 170 to an IP network 400, which is included in a usual specification in this type of video apparatus, is connected to the system controller 170. The digital television 100 in this embodiment is connected to the IP network 400 through the IP network interface unit 151 and connected to an information source such as a server 450 via the IP network 400. Thus, the digital television 100 is capable of exchanging information in a wide area. Moreover, the system controller 170 can supply a command for tuning or the like to a tuner of another apparatus that can exchange packet data via the IP network 400.

Furthermore, a DLNA interface unit 152 is also connected to the system controller 170. The DLNA interface unit 152 is a unit for performing connection with an external apparatus such as a PVR in a communication system complying with a guideline set by the Digital Living Network Alliance (DLNA) for a specification for connecting digital AV apparatuses each other and connecting personal computers each other to mutually use data such as moving pictures, music, still images, and the like in a so-called home network. In the example shown in the figure, the digital television 100 and the PVR 300 (PVR-1) exchange control signals for the operation through the DLNA interface unit 152.

The system controller 170 is adapted to function as respective units, which are important components according to the embodiment of the invention, or sections constituting the components according to actions of respective relevant functional units thereof.

The control operation, pattern projecting unit that projects a control operation pattern (e.g., a pattern representing buttons corresponding to functions of operation keys of a dedicated remote controller attached to the PVR, the VCR, or the like) on the display screen includes the OSD unit 131 and a relevant functional unit of the system controller 170. The control operation pattern specifies a type of control operation for control of a predetermined control object apparatus (e.g., a PVR or a VCR).

The control operation specifying signal generating unit generates, when deciding operation for a position of the cursor is recognized in response to the deciding operation signal Sd when the cursor moved in response to the cursor moving operation signal Sc from the remote controller 200 is located in a portion representing one type of control operation in the control operation pattern projected on the display screen by the control operation pattern projecting unit, a control operation specifying signal representing the one type of control operation. The control operation specifying signal generating unit includes the radio communication unit 182 and a relevant functional unit of the system controller 170.

The control object apparatus operation signal forming unit forms a control object apparatus operation signal conforming to operation of the control object apparatus (e.g., in the case of FIG. 1, the PVR 300) on the basis of the control operation specifying signal generated by the control operation specifying signal generating unit. The control object apparatus operation signal forming unit includes a relevant functional unit of the system controller 170 that functions to form a proper signal by checking a relation between specific operation and a signal conforming to a model or the like of a control object apparatus performing the operation with reference to the memory 172 and table data prepared in the memory 172.

The control object apparatus operation signal sending unit sends the control object apparatus operation signal formed by the control object apparatus operation signal forming unit to the control object apparatus. The control object apparatus operation signal sending unit may include the IP network interface unit 151 and a relevant functional unit of the system controller 170. When the control object apparatus operation signal sending unit has this constitution, it is possible to supply a control object apparatus operation signal (a command) for tuning or the like to a tuner 121 (a tuner as another apparatus or, when the digital television 100 includes plural tuners, the tuners), a PVR, or the like. The tuner 121, the PVR, or the like is constituted to be capable of exchanging packet data from the IP network interface unit 151 via the IP network 400.

The control object apparatus operation signal sending unit may include the DLNA interface unit 152 and a relevant functional unit of the system controller 170. When the control object apparatus operation signal sending unit has this constitution, the digital television 100 and the PVR 300 (the PVR-1) performs exchange of a control signal for operation thereof through the DLNA interface unit 152 as in the example shown in FIG. 1. Exchange of the control signal may be performed by wire or may be performed by radio. Since the DLNA interface unit 152 is provided, it is possible to realize a way of making it possible to control various control object apparatuses complying with the guideline set by the DLNA and exchange data such as contents.

The control object apparatus operation signal sending unit may include an infrared ray projecting unit 183 and a relevant functional unit of the system controller 170. The infrared ray projecting unit 183 is constituted to project a control signal of an infrared ray in a general infrared ray remote controller, which is attached to a control object apparatus, and connected to the system controller 170 to operate under the control thereof and the system controller 170.

When the control object apparatus operation signal sending unit has this constitution, a relation between the display control device and various control object apparatuses (in the figure the PVR 300, that is, the PVR-2 is shown) is completely the same as the relation in the case in which the control object apparatuses are operated by an infrared ray type remote controller widely used. On the control object apparatus side, extremely wide-ranging apparatuses including those of old models can be controlled as apparatuses to be controlled that are components of the system according to embodiments of the invention.

The input switching unit 161 selects a video information source, from which video information is supplied to the liquid crystal display 160, according to operation for selecting a video information source for the operation unit 171 by the user or a command given to the input switching unit 161 from the system controller 170 in response to a signal for selecting a video information source that is received by the infrared ray receiving unit 181 on the basis of remote operation. Consequently, an output (a tuner output) of the video processing unit, a reproduction output of the PVR 300, or an output from other video signal sources is selected according to discretion of the user and supplied to the liquid crystal display 160. Consequently, a video is projected.

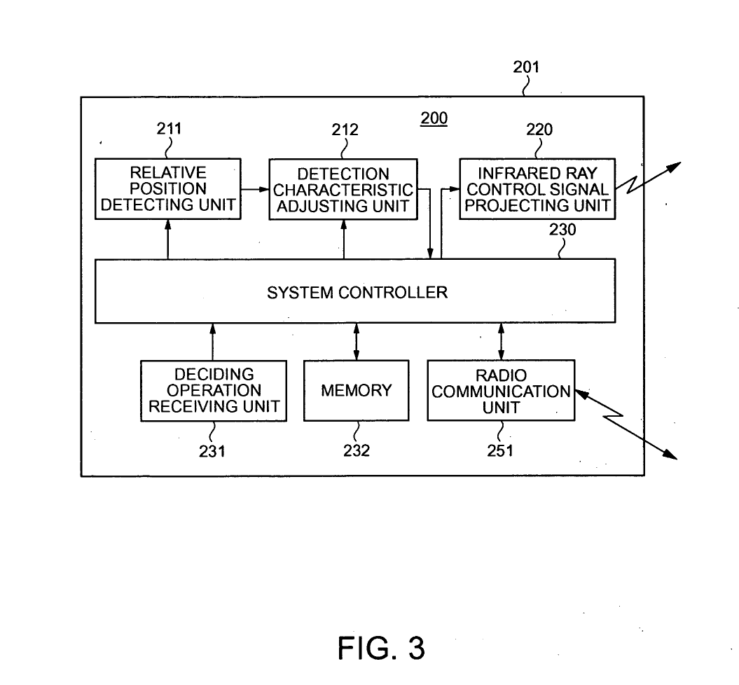

FIG. 3 is a block diagram showing a constitution of the remote controller 200 in the control system in FIG. 1. In the independent housing 201 explained with reference to FIG. 1, a relative position detecting unit 211 including a publicly-known inertia sensor, a so-called gyro, and the like that detects a relative change in a position of the housing 201 in a non-contact manner is provided. There is an inertial sensor that is extremely small and excellent in detection accuracy among publicly-known inertia sensors developed recently. Thus, if such a sensor is applied to the remote control device, it is possible to accurately detect a position and a posture of the remote control device. A detection characteristic adjusting unit 212 that adjusts a detection characteristic in the relative position detecting unit 211 by, for example, subjecting the detection characteristic to filtering processing with a characteristic variable filter is provided in the hosing 201. The detection characteristic adjusting unit 212 is connected to a system controller 230 such that an output of the detection characteristic adjusting unit 212 is supplied to the system controller 230.

In detecting a relative change in a position and a posture of the housing 201, a correspondence relation of a detection value with respect to an amount and speed of the relative change is appropriately changed by the detection characteristic adjusting unit 212. This makes it possible to select, according to discretion of the user, operation for remote control satisfactorily conforming to conditions such as a purpose, a place, and time for using the remote control device (the remote controller 200), and personality and intuition of the user. A change of characteristic of the filter can be performed from a not-shown predetermined adjusting unit.

The system controller 230 includes a microprocessor as a main component. The microprocessor comprehensively controls control systems of the remote controller 200 and executes various arithmetic operations. The system controller 230 is adapted to function as respective units, which are important components according to the embodiment of the invention, according to actions of respective relevant functional units thereof. An infrared control signal projecting unit 220 that emits a usual control signal of an infrared ray explained with reference to FIG. 1 is also connected to the system controller 230. In other words, the infrared control signal projecting unit 220 emits a control signal in response to supply of a relative position detection signal, which is outputted through the relative position detecting unit 211 and the detection characteristic adjusting unit 212 when the user of the remote controller 200 displaces the housing 201 in a specific motion (slightly swinging motion), to the system controller 230.

A control signal from a deciding operation receiving unit 231 is connected to the system controller 230 such that an operation signal from the deciding operation receiving unit 231 is supplied to the system controller 230. The deciding operation receiving unit 231 include, as a component, the deciding operation button 202 (FIG. 1) provided on the upper surface of the housing 201 of the remote controller 200 and receives deciding operation applied to the deciding operation button 202 by the user. The deciding operation signal forming unit that forms a deciding operation signal in response to operation applied to the deciding operation receiving unit includes the deciding operation button 202, the deciding operation receiving unit 231, and a relevant functional unit of the system controller 230.

A memory 232 is annexed to the system controller 230 such that the system controller 230 can access the memory 232 and exchange data with the memory 232.

In particular, a radio communication unit 251 for performing radio communication with the digital television 100 as described above with reference to FIG. 1 is provided in the remote controller 200. The radio communication unit 251 is connected to the remote controller 200 such that operations of the radio communication unit 251 are controlled by the system controller 230.

In the remote controller 200 according to the embodiment of the invention, the user holds the housing 201, moves the remote controller 200 toward a cursor (e.g., a cursor pointer of an arrow shape) projected on, for example, the screen 102 of the digital television 100 in such a manner as to draw a moving locus thereof, and changes a position and a posture of the remote controller 200. Displacement data corresponding to a detection value generated by the relative position detecting unit 211 and supplied via the detection characteristic adjusting unit 212 is generated in the system controller 230 in response to this operation by the user.

This displacement data is equivalent to a cursor moving operation signal for moving the cursor projected on the screen 102. The cursor moving operation signal forming unit forms a cursor moving operation signal for moving a cursor projected on a display screen of a predetermined display control device according to a detection output of the relative displacement detecting unit. The cursor moving operation signal forming unit includes the relative position detecting unit 211, the detection characteristic adjusting unit 212, and a relevant functional unit of the system controller 230.

On the other hand, the cursor moving operation signal formed by the cursor moving operation signal forming unit as described above is subjected to required signal conversion processing (conversion processing for a format of data) by the system controller 230. The cursor moving operation signal is converted into a radio signal of a predetermined form conforming to the digital television 100 (the radio communication unit 182 thereof) serving as the display control device in the radio communication unit 251 operating under the control of the system controller 230 and sent to the outside.

Similarly, the deciding operation signal formed by the deciding operation signal forming unit as described above is subjected to required signal conversion processing (conversion processing for a format of data) by the system controller 230. The deciding operation signal is converted into a radio signal of a predetermined form conforming to the digital television 100 (the radio communication unit 182 thereof) serving as the display control device in the radio communication unit 251 operating under the control of the system controller 230 and sent to the outside.

The cursor moving operation signal sending unit sends a cursor moving operation signal to the display control device as a signal of a predetermined form. The deciding operation signal sending unit sends a deciding operation signal to the display control device as a signal of a predetermined form. The cursor moving operation signal sending unit and the deciding operation signal sending unit include the radio communication unit 251 and a relevant functional unit of the system controller 230. The radio communication unit 251 is constituted to perform radio communication complying with Bluetooth®, IEEE803.11a, or IEEE803.11b under the control of the system controller 230 in the same manner as the radio communication unit 182 of the digital television 100 in FIG. 2.

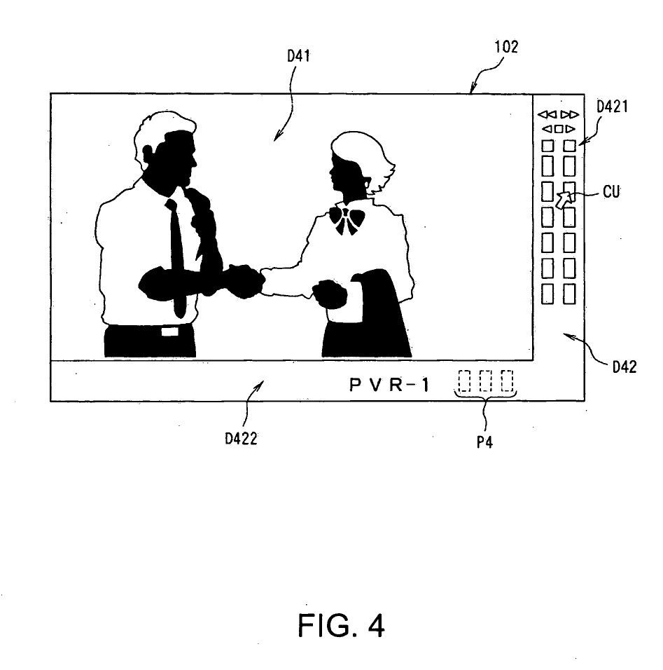

FIG. 4 is a diagram representing an example of display on a screen in a control mode of a digital television serving as the display control device according to the embodiment of the invention.

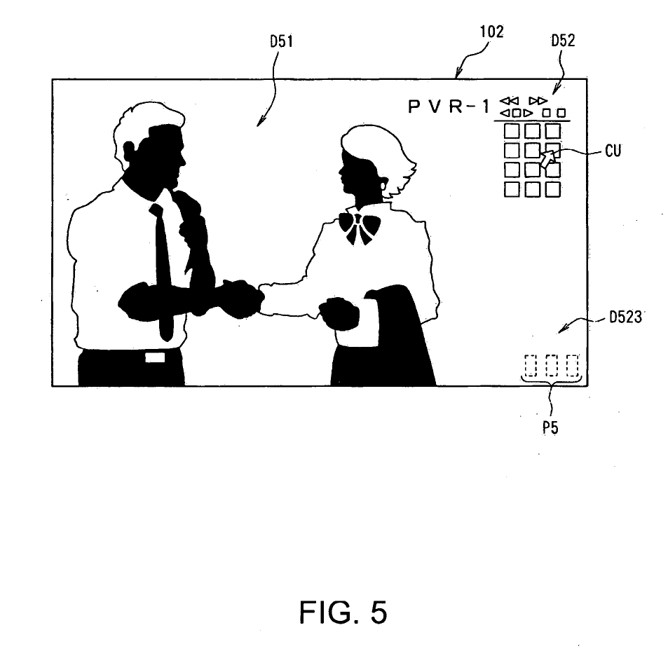

FIG. 5 is a diagram representing an example of display on a screen in a control mode of a digital television serving as a display control device as a modification of the embodiment in FIG. 4.

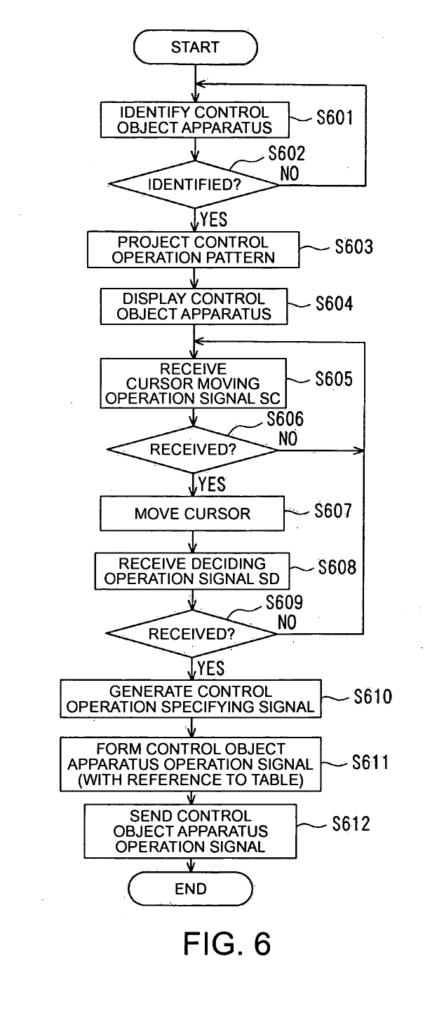

FIG. 6 is a flowchart representing operations in the control mode of the display control devices in FIGS. 1, 2, 4, and 5.

Operations of the display control device will be explained according to the flowchart in FIG. 6 with reference to FIG. 4, FIG. 5, and the like according to circumstances. After the display control device is started, it is possible to give a usual control signal of an infrared ray or the like to the light-receiving window 105 (the infrared ray receiving unit 181 in FIG. 2) of the digital television 100 and bring the display control device into a control mode for controlling a control object apparatus via this digital television by performing specific operation, for example, swinging the remote controller 200 in a predetermined form (e.g., swinging a front end thereof to be shaken vertically) or continuously pressing the deciding operation button 202 for a predetermined time (e.g., two seconds).

When the display control device shifts to the control mode, the display control device starts an operation for identifying a selected control object apparatus (step S601). Selection of a control object apparatus is performed by, for example, giving a usual control signal of an infrared ray to the digital television 100 according to operation of the remote controller 200 in the same manner as the operation for setting a control mode. As another method, it is also possible that a screen for selecting a control object apparatus is projected at the beginning of start of the digital television 100 and operation for moving a cursor and deciding a position of the cursor on the screen is performed to select a control object apparatus.

When the control object apparatus selected is a video apparatus that should be connected to the liquid crystal display 160, a circuit is switched such that an output of the control object apparatus is supplied to the liquid crystal display 160 through the input switching unit 161 explained with reference to FIG. 2.

The display, control device waits for the selection or connection of the control object apparatus to be identified (step S602). When the selection or connection of the control object apparatus is identified, the display control device sets a display form of the screen 102 as control operation pattern projection display (step S603). Examples of this control operation pattern projection display are shown in FIGS. 4 and 5.

In the example of display in FIG. 4, a video display area D41 is slightly reduced in an upper left direction of the screen 102. A control information display area D42 of a single base color is set in a shape in which belt-like areas D421 and D422 of fixed widths along the right end and the lower end of the screen 102 are orthogonal to each other at the lower right of the screen 102.

In the area D421, a control operation pattern (e.g., pattern display like buttons corresponding to functions of operation keys of a dedicated remote controller attached to a PVR) specifying a type of control operation (start, stop, pause, EPG operation, etc.) applied to the control object apparatus is projected by the control operation pattern projecting unit.

On the other hand, in the example of display in FIG. 5, an entire are of the screen 102 is set as a video display area D51. A control operation pattern is superimposed on a portion D52 relatively closer to a peripheral part (a portion closer to the upper right in the example shown in the figure) of the video display area D51.

After step S603, the display control device displays a name, an abbreviation of the name, or the like of the control object apparatus identified on the screen 102 (step S604). In the example of display in FIG. 4, “PVR-1” is displayed in the control information display area D422 in the lower part of the screen. In the example of display in FIG. 5, “PVR-1” is superimposed on the portion D52 at the upper right of the screen 102.

Subsequently, the display control device shifts to an operation for receiving the cursor moving operation signal Sc from the remote controller 200 (step S605). The display control device waits for the cursor moving operation signal Sc to be received (step S606). Every time the cursor moving operation signal Sc is received, the display control device moves the cursor to a position corresponding to the cursor moving operation signal Sc received (step S607). Such a cursor moving operation is repeated until, after step S607, the display control device shifts to an operation for receiving the deciding operation signal Sd from the remote controller 200 (step S608) and the deciding operation signal Sd is received (step S609).

As a result, the cursor repeatedly moves to a position intended by the user. A control operation specifying signal is formed according to a position where the reception of the deciding operation signal Sd is recognized (e.g., a position overlapping some part of the pattern display like buttons corresponding to functions of operation keys of a dedicated remote controller attached to a PVR) (step S610). In the example in FIG. 4, an arrow-shaped cursor CU is located on the pattern display like buttons in the control information display area D421. In the example in FIG. 5, the arrow-shaped cursor CU is located on the pattern display like buttons in the portion D52 at the upper right of the screen 102. A control operation specifying signal corresponding to each position is formed.

The control operation specifying signal is a signal for specifying a type of control operation (start, stop, pause, EPG operation, etc.). When the system controller 170 explained with reference to FIG. 2 refers to the table prepared in the memory 172 annexed thereto, a control object apparatus operation signal conforming to the control object apparatus (PVR-1 in the example described above) is formed on the basis of this signal (step S611).

The control object apparatus operation signal formed in step S611 is sent to the control object apparatus as an infrared control signal by, for example, the control object apparatus operation signal sending unit including the infrared ray projecting unit 183 and a relevant functional unit of the system controller 170 explained with reference to FIG. 2 (step S612). As already described, other than the form described above, the control object apparatus operation signal sending unit may include the IP network interface unit 151 and a relevant functional unit of the system controller 170 or may include the DLNA interface unit 152 and a relevant functional unit of the system controller 170. A state in which the control object apparatus operation signal is sent to the control object apparatus by the control object apparatus operation signal sending unit of these forms is as explained with reference to FIG. 2.

According to the display control device (the digital television) explained above, it is possible to obtain control object apparatus operations signals for controlling a large number of or many kinds of control object apparatuses, respectively, and control the respective control object apparatuses according to a combination of one remote control device and one display control device with reference to table data. The table data specifies a relation of control object apparatus operation signals with respect to respective control object apparatuses corresponding to types of control operation.

In FIG. 4 referred to above, a pattern P4 indicated by a broken line closer to the right of the area D422 on the screen 102 is a pattern of control keys (buttons) used for performing control with special keys peculiar to a specific control object apparatus. The control is not included in a control operation (a control operation pattern) in a standard general-purpose control mode displayed in the area D421. The display control device shifts to a mode for performing control with such special keys from the standard general-purpose control mode by performing operation as required. The display control device uses functions of the special keys in the mode.

Similarly, in FIG. 5, a pattern P5 indicated by a broken line superimposed on a portion D523 at the lower right on the screen 102 is a pattern of control keys (buttons) used for performing special control peculiar to a specific control object apparatus. The control is not included in a control operation (a control operation pattern) in a standard general-purpose control mode displayed in the portion of D52. As in the case of FIG. 4, the display control device shifts to a mode for performing control with such special keys from the standard general-purpose control mode by performing operation as required. The display control device uses functions of the special keys in the mode.

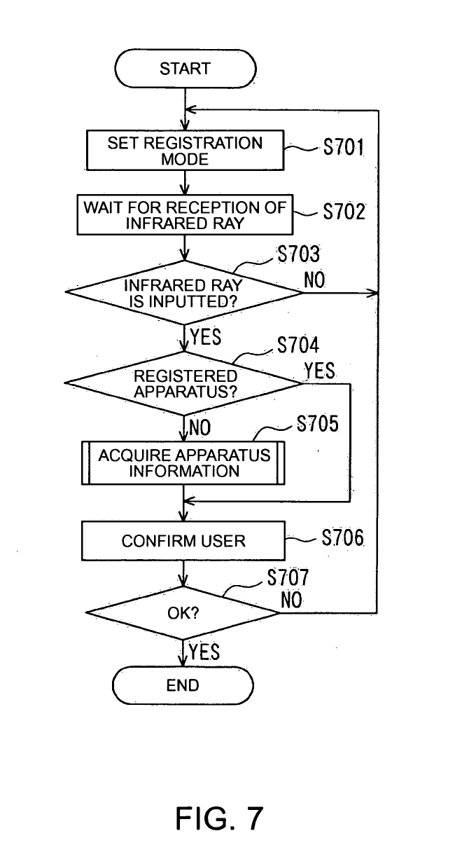

FIGS. 7, 8, and 9 are flowcharts representing preparation operations in giving functions allowing the display control device (the digital television) to perform the operations in FIG. 6 to the display control device. In particular, the flowcharts relate to a preparation operation for allowing the display control device to play the functions of forming a control object apparatus operation signal conforming to each control object apparatus and sending the control object apparatus operation signal in steps S611 and S612 in the flowchart in FIG. 6.

FIG. 7 is a flowchart representing an outline of a preparation operation at the time when a signal conversion table for allowing the display control device (the digital television 100) to form and send a control object apparatus operation signal serving as a control signal of an infrared ray, which is the same as that for a dedicated remote controller attached to each apparatus, for each control object apparatus such as a PVR or a VCR is registered in, for example, the memory 172 explained with reference to FIG. 2.

First, when the user performs mode selection, for example, using a basic operation function by an infrared ray of the remote controller 100 described above, the display control device 100 enters a registration mode (step S701). Subsequently, according to selection operation performed by the user, the display control device 100 enters an operation for waiting for reception of an infrared ray from an infrared ray remote controller attached to a control object apparatus (e.g., PVR-1) (step S702).

Subsequently, the display control device 100 waits for an input of an infrared ray from the relevant remote controller (step 5703). When an infrared ray is inputted, the display control device 100 judges, on the basis of the input, whether the control object apparatus is an apparatus for which data of an infrared ray is already registered (step S704).

When it is judged in step S704 that the control object apparatus is not an apparatus for which data of an infrared ray is already registered, in the next step S705, the display control device 100 enters a routine of apparatus information acquisition for acquiring information concerning the control object apparatus (data concerning a signal of an infrared ray) anew. When it is judged that the control object apparatus is an apparatus for which data of an infrared ray is already registered, the display control device 100 waits for confirmation by the user (step S706). When judgment of the user is affirmative (step S707), the display control device 100 ends this preparation operation. When judgment of the user is not affirmative (step S707), the display control device 100 returns to step S701.

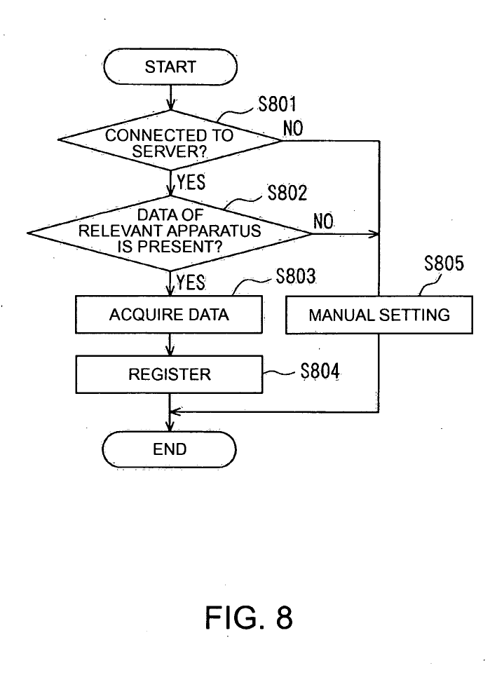

FIG. 8 is a flowchart representing details of the apparatus information acquisition routine of step S705 in the flowchart in FIG. 7. The display control device 100 judges whether a mode for connecting information on the control object apparatus (data concerning a signal of an infrared ray) to the server 450 through the IP network 400 in FIG. 2 and acquiring the information (data) from the server 450 is selected (step S801). When the mode for making connection to the serer and acquiring data is selected, the display control device 100 judges whether data of an infrared ray concerning the relevant control object data is held by the server (step S802).

When it is judged in step S802 that the data of an infrared ray concerning the relevant control object apparatus is held by the server, the display control device 100 acquires the relevant data through a predetermined route (in FIG. 2, from the server 450 to the IP network 400, the IP network interface unit 151, and the system controller 170) (step S803) and registers the data in the memory 172 (step S804).

When the mode for making connection to the server and, acquiring data is not selected in step S801, the user manually sets required data (step S805).

In the apparatus of the form explained on the basis of steps S802 to S804 of the flowchart in FIG. 8, the control object apparatus operation signal forming unit can form a control object apparatus operation signal corresponding to a control operation specifying signal, which is supplied to the control object apparatus operation signal forming unit, with reference to the table data including data acquired from a database or the like on the outside by the data acquiring unit through the signal transmission path of the IP network. Thus, it is possible to easily cope with update and the like of the data forming the table data.

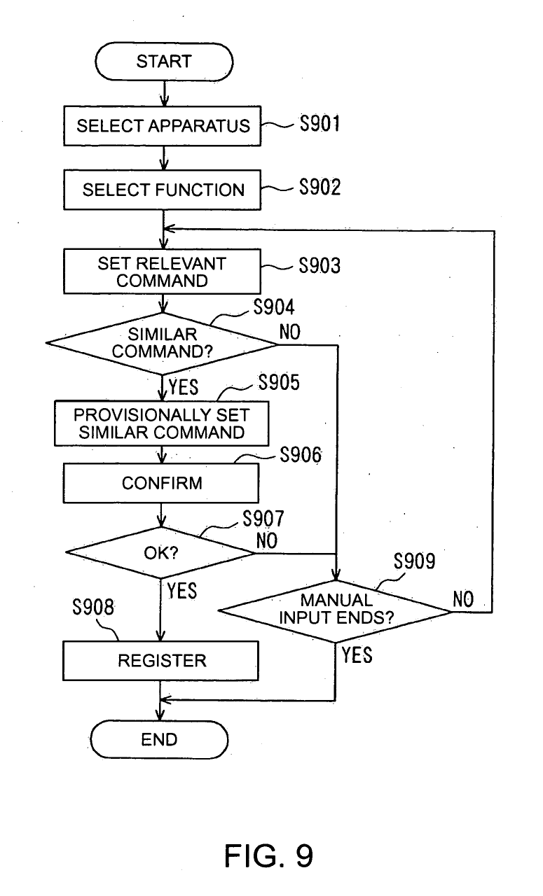

FIG. 9 is a flowchart concerning a procedure at the time when the user manually sets required data in step S805 in the flowchart in FIG. 8.

First, the user manually selects a control object apparatus that is an object of data registration (step S901). This operation is the same as the operation explained concerning step S601 in the flowchart in FIG. 6. Subsequently, the user selects a function for remote operation of the control object apparatus selected in step S901 (step S902). This function is, for example, an operation function corresponding to the pattern of respective buttons in the example of the control operation pattern projection display explained with reference to FIGS. 4 and 5.

Subsequently, the user shifts to a state in which a command (command data) of a control object apparatus corresponding to the function selected in step S902 can be manually set (step S903). This setting is performed by, for example, interactive input operation using a GUI screen projected on the screen 102. When the user shifts to step S903, presence or absence of a registered command similar to the command of the apparatus selected as the control object apparatus at that point is judged (step S904).

Presence or absence of a similar registered command is judged in this way. This is because, for example, since an identical operation signal (code data) is often allocated to an identical function (operation) in products (PVRs, VCRs, etc.) of the same manufacturer, it is highly likely that extremely efficient work is performed compared with manual input of a command for each function.

When it is judged in step S904 that a registered command similar to the command of the apparatus selected as the control object apparatus at that point is present, the user provisionally sets (registers) the similar registered command as a command of the apparatus selected as the control object apparatus at that point (step S905) and confirms whether the registration is appropriate (step S906).

When it is confirmed that the provisional registration is appropriate, the user regularly registers the command as it is (step S908). When it is judged in step S904 that a similar registered command is not present and when it is judged in step S907 that the provisional registration is not appropriate, the user performs manual input and waits for this work to end (step S909). When the work ends, the user ends the setting procedure.

According to the apparatus explained with reference to the flowchart in FIG. 9, it is possible to obtain control object apparatus operations signals for controlling a large number of or many kinds of control object apparatuses, respectively, and appropriately control the respective control object apparatuses according to a combination of one remote control device and one display control device with reference to table data complying with an intension of the user concerning respective control object apparatuses. The table data includes data formed by the user through the GUI data forming unit at the time of initial use or the like.

Concerning the examples of display on the screens in FIGS. 4 and 5, a control operation pattern projected by the control operation pattern projecting unit is explained as an control operation pattern that complies with a control operation of the standard general-purpose control mode and does not always correspond to respective control object apparatuses (e.g., similar to layouts of operation keys of dedicated remote controllers attached to respective apparatuses). However, it goes without saying that the idea of the invention includes a technical idea for projecting control operation patterns corresponding to respective control object apparatuses and controlling the control object apparatuses using the control operation patterns.

In such an embodiment, in brief, the control operation patterns projected on the screens in FIGS. 4 and 5 by the control operation pattern projecting unit are control operation patterns corresponding to the respective control object apparatuses, for example, similar to layouts of operation keys of dedicated remote controllers attached to the respective apparatuses.

In order to realize functions of projecting such control operation patterns and forming a control object apparatus operation signal in performing control operation using the control operation patterns, the display control device further includes a pattern data acquiring unit and a pattern correspondence operation data acquiring unit. The pattern data acquiring unit acquires data representing a control operation pattern including respective patterns specifying types of control operation for control of a relevant control object apparatus from the outside through a signal transmission path. The pattern correspondence operation data acquiring unit acquires a correspondence relation between the respective patterns in the control operation pattern and the types of control operation for control of the relevant control object apparatus from the outside through the signal transmission path.

According to such an embodiment, a control operation pattern is projected on the display screen on the basis of data acquired from a database or the like on the outside through a signal transmission path such as an IP network by the pattern data acquiring unit. Thus, even in a tendency in which new apparatuses that can be control object apparatuses are added, it is possible to easily cope with the new apparatuses by acquiring control operation patterns conforming to the new apparatuses and the like from the database or the like on the outside with the pattern data acquiring unit.

Moreover, a control object apparatus operation signal is formed on the basis of data (a table) acquired from the database or the like on the outside with the pattern correspondence operation data acquiring unit through the signal transmission path such as an IP network. Thus, even if a new apparatus that can be a control object apparatus is added or a control code is changed, it is possible to easily cope with the addition of the new apparatus or the change of the control code.

In the embodiment explained above, the digital television 100 may include a function of automatically executing, when operation for causing, for example, a PVR serving as a control object apparatus to record a program is performed by the remote controller 200, a series of sequence such as starting a tuner of the digital television 100 at time of the recording, performing specific tuning, supplying contents of a broadcast tuned in to the PVR, and, when a recording end time comes, turning off the PVR and the tuner. Such a series of sequence may be adaptively revised according to a learning function of the digital television 100 (which can be gradually cultivated according to achievements of control operation) in principle. In addition, according to a desire of a user, learning contents of the digital television 100 may be allowed to be properly edited using a personal computer connected thereto via the DLNA interface unit 152 and the IP network interface unit 151. For example, alteration operation for adjusting a time axis of the sequence corresponds to the edition.

The entire disclosure of Japanese Patent Application No. 2005-055438, filed Mar. 1, 2005 is expressly incorporated by reference herein.

What is claimed is:

1. A remote control device comprising:
a housing that has an external dimension allowing the housing to be handled by a user such that a position and a posture thereof are changed and houses predetermined components therein;
a relative displacement detecting unit that detects a relative change in the position and the posture of the housing in a non-contact manner;
a cursor moving operation signal forming unit that forms a cursor moving operation signal for moving a cursor, which is projected on a display screen of a predetermined display control device, according to a detection output of the relative displacement detecting unit;
a cursor moving operation signal sending unit that sends the cursor moving operation signal formed by the cursor moving operation signal forming unit to the display control device as a signal of a predetermined form;
a deciding operation receiving unit that receives deciding operation by the user concerning a position of the cursor projected on the display screen of the display control device;
a deciding operation signal forming unit that forms a deciding operation signal in response to the operation applied to the deciding operation receiving unit; and
a deciding operation signal sending unit that sends the deciding operation signal formed by the deciding operation signal forming unit to the display control device as a signal of a predetermined form.

2. A display control device that moves a cursor projected on a display screen in response to a cursor moving operation signal sent from a predetermined remote control device and recognizes deciding operation for a position of the cursor in response to a deciding operation signal sent from the remote control device, the display control device comprising:
a control operation pattern projecting unit that projects a control operation pattern, which specifies a type of control operation for control of a predetermined control object apparatus, on the display screen;
a control operation specifying signal generating unit that generates, when the deciding operation for a position of the cursor is recognized in response to the deciding operation signal when the cursor moved in response to the cursor moving operation signal is located in a portion representing one type of control operation in the control operation pattern projected on the display screen by the control operation pattern projecting unit, a control operation specifying signal representing the one type of control operation;
a control object apparatus operation signal forming unit that forms a control object apparatus operation signal conforming to operation of the control object apparatus on the basis of the control operation specifying signal generated by the control operation specifying signal generating unit; and
a control object apparatus operation signal sending unit that sends the control object apparatus operation signal formed by the control object apparatus operation signal forming unit to the control object apparatus.

3. A display control device that moves a cursor projected on a display screen in response to a cursor moving operation signal sent from a predetermined remote control device and recognizes deciding operation for a position of the cursor in response to a deciding operation signal sent from the remote control device, the display control device comprising:
a control operation pattern selecting and projecting unit that projects a control operation pattern including respective patterns, which specify a type of control operation for control of one control object apparatus among predetermined plural control object apparatuses, on the display screen selectively out of displayable control operation patterns corresponding to the plural control object apparatuses;
a control object apparatus operation signal forming unit that forms, when the deciding operation for a position of the cursor is recognized in response to the deciding operation signal when the cursor moved in response to the cursor moving operation signal is located in a portion representing one type of control operation in the control operation pattern projected on the display screen by the control operation pattern projecting unit, a control object apparatus operation signal conforming to operation of the control object apparatus corresponding to the one type of control operation; and
a control object apparatus operation signal sending unit that sends the control object apparatus operation signal formed by the control object apparatus operation signal forming unit to the control object apparatus.

4. The display control device according to claim 2, wherein the control object apparatus operation signal forming unit forms, on the basis of the control operation specifying signal supplied thereto, a control object apparatus operation signal corresponding to the control operation specifying signal with reference to table data specifying a relation among control object apparatus operation signals for respective control object apparatuses corresponding to types of control operation.

5. The display control device according to claim 4, further comprising a data acquiring unit that acquires data forming the table data from the outside through a signal transmission path, wherein
the control object apparatus operation signal forming unit forms, on the basis of the control operation specifying signal supplied thereto, a control object apparatus operation signal corresponding to the control operation specifying signal with reference to table data including the data acquired by the data acquiring unit.

6. The display control device according to claim 4, further comprising a GUI data forming unit that forms data forming the table data by receiving operation by the user, wherein
the control object apparatus operation signal forming unit forms, on the basis of the control operation specifying signal supplied thereto, a control object apparatus operation signal corresponding to the control operation specifying signal with reference to the table data including the data formed by the GUI data forming unit.

7. The display control device according to claim 2, wherein the control object apparatus operation signal sending unit sends a control object apparatus operation signal of an infrared ray to the control object apparatus.

8. The display control device according to claim 2, wherein the control object apparatus operation signal sending unit sends a control object apparatus operation signal to the control object apparatus in a communication system complying with a guideline set by the Digital Living Network Alliance (DLNA).

9. The display control device according to claim 3, further comprising a pattern data acquiring unit that acquires data representing a control operation pattern including respective patterns, which specify types of control operation for control of a corresponding control object apparatus, from the outside through a signal transmission path, wherein
the control operation pattern selecting and projecting unit projects a control operation pattern on the display screen on the basis of the data acquired through the pattern data acquiring unit.

10. The display control device according to claim 3, further comprising a pattern correspondence operation data acquiring unit that acquires data representing a correspondence relation between respective patterns in the control operation pattern and types of control operation for control of a corresponding control object apparatus from the outside through a signal transmission path, wherein
the control object apparatus operation signal forming unit forms a control object apparatus operation signal on the basis of the data acquired by the pattern correspondence operation data acquiring unit.

11. The display control device according to claim 10, further comprising a GUI data forming unit that forms data by receiving interactive operation using a GUI by the user, wherein
the pattern correspondence operation data acquiring unit acquires data representing a correspondence relation between respective patterns in the control operation pattern and types of control operation for control of a corresponding control object apparatus through the GUI data forming unit.

12. The display control device according to claim 3, wherein the control object apparatus operation signal sending unit sends a control object apparatus operation signal of an infrared ray to the control object apparatus.

13. The display control device according to claim 3, wherein the control object apparatus operation signal sending unit sends a control object apparatus operation signal to the control object apparatus in a communication system complying with a guideline set by the Digital Living Network Alliance (DLNA).
